(19) United States
(12) Patent Application Publication
(10) Pub. No.: US 2023/0245014 A1
(43) Pub. Date: Aug. 3, 2023

(54) SYSTEMS AND METHODS FOR ASSEMBLING MERCHANDISE ITEMS

(71) Applicant: Walmart Apollo, LLC, Bentonville, AR (US)

(72) Inventors: Jeremy L. Velten, Bella Vista, AR (US); Leigh Ann Marie Scobey, Bentonville, AR (US); William Mark Propes, Bentonville, AR (US)

(21) Appl. No.: 18/156,886

(22) Filed: Jan. 19, 2023

Related U.S. Application Data
(60) Provisional application No. 63/304,774, filed on Jan. 31, 2022.

(51) Int. Cl. G06Q 10/0631; G06Q 10/087; G06Q 30/02

(52) U.S. Cl. CPC G06Q 10/063112; G06Q 10/087; G06Q 30/0281

(57) ABSTRACT

There are provided systems and methods for assembling merchandise ordered by customers. In one form, the system may include: a merchandise order interface for receiving orders placed by customers; a retailer facility with shelving locations corresponding to categories of merchandise items; and a merchandise database containing records of the merchandise categories at the retailer facility and identifying a group of difficult-to-pick merchandise categories, including items stored in locked cases and in non-public areas of the retailer facility. The system may also include a control circuit that: receives merchandise orders, determines merchandise items in the difficult-to-pick merchandise categories, selects a first picker with access to the difficult-to-pick items, instructs the first picker to assemble them, instructs a second picker to assemble merchandise items not within the difficult-to-pick merchandise categories, and instructs the second picker to consolidate the difficult-to-pick items and the items assembled by the second picker.

### CROSS-REFERENCE TO RELATED APPLICATION

This application claims the benefit of U.S. Provisional Application No. 63/304,774, filed Jan. 31, 2022, which is incorporated by reference in its entirety herein.

### TECHNICAL FIELD

This invention relates generally to assembling merchandise items, and more particularly, to assembling merchandise items that are part of a merchandise order of a customer at retailer facilities.

### BACKGROUND

In the retail setting, customers are placing merchandise orders that are then assembled at retailer facilities by pickers. Many categories of merchandise items are relatively easy to select or pick from shelves and other locations. However, it has been found that certain categories of merchandise items are relatively difficult to pick because they may, for example, be in locked cases or in non-public areas of the retailer facility.

It is therefore desirable to develop an order assembly approach that addresses difficult-to-pick areas and products. Examples of difficult-to-pick areas and products may include entertainment, apparel, and seasonal products. There is a need to develop an order assembly approach that accounts for both types of products: difficult-to-pick merchandise items and other items that are not considered difficult-to-pick.

### BRIEF DESCRIPTION OF THE DRAWINGS

Disclosed herein are embodiments of systems, apparatuses and methods for use in assembling merchandise items ordered by customers. This description includes drawings, wherein:

FIG. 1 is a block diagram in accordance with some embodiments;

FIG. 2 is a flow diagram in accordance with some embodiments; and

FIG. 3 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification do not all refer to the same embodiment.

Generally speaking, pursuant to various embodiments, systems, apparatuses and methods are provided herein for assembling merchandise items ordered by customers. In one form, the system includes: a merchandise order interface configured to receive a merchandise order placed by a customer and including a plurality of merchandise items; a retailer facility comprising a plurality of shelving locations, each shelving location corresponding to a predetermined category of merchandise item; and a merchandise database containing a plurality of records of the merchandise categories at the retailer facility, the merchandise database identifying a predetermined group of difficult-to-pick merchandise categories comprising items stored in locked cases and in non-public areas of the retailer facility. The system further includes a control circuit communicatively coupled to the merchandise order interface and the merchandise database, the control circuit configured to: receive the merchandise order from the merchandise order interface; determine merchandise items in the merchandise order that are within the predetermined group of difficult-to-pick merchandise categories; select a first picker with access to the difficult-to-pick merchandise items; instruct the first picker to assemble difficult-to-pick merchandise items and deliver them to a predetermined location; instruct a second picker to assemble merchandise items not within the predetermined group of difficult-to-pick merchandise categories; and instruct the second picker to consolidate the difficult-to-pick merchandise items delivered to the predetermined location and the merchandise items assembled by the second picker.

In some implementations, the system further includes a pick database communicatively coupled to the control circuit, the pick database containing a first-time pick metric corresponding to each shelving location, the first-time pick metric determined by the frequency of an individual locating a predetermined category of merchandise item corresponding to each shelving location; wherein the predetermined group of difficult-to-pick merchandise categories further comprises categories with first-time pick metrics below a predetermined threshold. In some implementations, the predetermined group of difficult-to-pick merchandise categories are selected from entertainment, apparel, and seasonal products. In some implementations, the first picker is selected from a department corresponding to the difficult-to-pick merchandise items. In some implementations, the control circuit is configured to: transmit the instruction to the first picker to assemble difficult-to-pick merchandise items to a mobile device of the first picker; and receive a response to the instruction from the first picker. In some implementations, the control circuit is configured to: transmit an instruction to assemble the difficult-to-pick merchandise items to a mobile device of a third picker if the first picker declines, the third picker having access to the difficult-to-pick merchandise items. In some implementations, the control circuit is configured to: determine that at least one of the difficult-to-pick merchandise items is an item intended for transport by a plurality of pickers; and select a plurality of pickers to transport the item to a designated area for pick up. In some implementations, the control circuit is configured to: receive a notification from the first picker that the difficult-to-pick merchandise items have been assembled; and notify the second picker that the difficult-to-pick merchandise items are ready for consolidation with merchandise items of the order assembled by the second picker. In some implementations, the control circuit is configured to: receive a notification that the merchandise order has been consolidated and is ready for pick up by the customer. In some implementations, selecting a first picker with access to the difficult-to-pick merchandise items includes accessing an active directory of pickers that are available at the retailer facility and determining a picker in a department corresponding to a difficult-to-pick merchandise item.

In another form, there is provided a method for assembling merchandise items ordered by customers. The method includes: receiving, by a control circuit communicatively coupled to a merchandise order interface and a merchandise database, a merchandise order from the merchandise order interface placed by a customer and including a plurality of merchandise items, wherein the retailer facility includes a plurality of shelving locations and each shelving location corresponds to a predetermined category of merchandise item, wherein a plurality of records are stored in the merchandise database of the merchandise categories at the retailer facility, wherein the merchandise database identifies a predetermined group of difficult-to-pick merchandise categories comprising items stored in locked cases and in non-public areas of the retailer facility; determining, by the control circuit, merchandise items in the merchandise order that are within the predetermined group of difficult-to-pick merchandise categories; selecting, by the control circuit, a first picker with access to the difficult-to-pick merchandise items; instructing, by the control circuit, the first picker to assemble difficult-to-pick merchandise items and deliver them to a predetermined location; instructing, by the control circuit, a second picker to assemble merchandise items not within the predetermined group of difficult-to-pick merchandise categories; and instructing, by the control circuit, the second picker to consolidate the difficult-to-pick merchandise items delivered to the predetermined location and the merchandise items assembled by the second picker.

As an overview, without limitation, this disclosure is directed generally to picking and assembling merchandise orders of customers. The term “picker” generally refers to individuals at the retailer facility who are selecting or picking merchandise from shelves and from other locations and may include employees, independent contractors, vendors, personal shoppers, and/or other individuals. It has been found that certain categories of merchandise items are relatively difficult to pick because they may, for example, be in locked cases, be in non-public areas of the retailer facility, or have low first-time pick metrics. A first-time pick metric or percentage is generally an indicator of how frequently a merchandise item was found at its designated location within the retailer facility by a picker the first time he or she looked for it at its designated location.

This disclosure is intended to assist with difficult-to-pick areas and products. Example areas include: entertainment, apparel, and seasonal products. In one form, the system may route picks in these areas and other areas to skilled pickers who work in the particular area. Dynamic criteria may be used for assigning items to a skilled picker. As the first-time pick percentage decreases, the system may assign a skilled picker to both make the pick and also work on the section/shelving locations to improve the first-time pick percentage.

In one aspect, the system may dynamically route picks for items which are difficult to pick to skilled pickers (rather than a general order filler). Items which are difficult to pick may include, for example: items that are locked in cases (such as wireless earbuds), items that are difficult to discern (such as ink cartridges), and items regularly stored in the backroom area of the retailer facility. The criteria used to dynamically assign the picks to skilled pickers include, for example: first time pick percentage, location, and locked status.

Further, in one aspect, the system may use some or all of the following steps, for example, to fill a customer order: (1) an order to be picked arrives in the queue of orders; (2) the system assigns order fillers for individual products (general order fillers/pickers for routine merchandise items and skilled pickers for difficult-to-pick merchandise items); (3) if the skilled picker is busy, he or she may postpone the action for a time period; (4) after the time period, the skilled picker may accept or deny the pick; (5) if the skilled picker denies the pick, the system may notify the next available skilled picker; (6) after the skilled picker completes the pick, the system may direct him or to temporarily place the pick in a particular service center or location; (7) the general order filler/picker may be notified to go to the service center to obtain the stored pick, when ready; and (8) the general order filler/picker may consolidates the customer's order to include both the routine merchandise items and the difficult-to-pick items, such as in totes/containers.

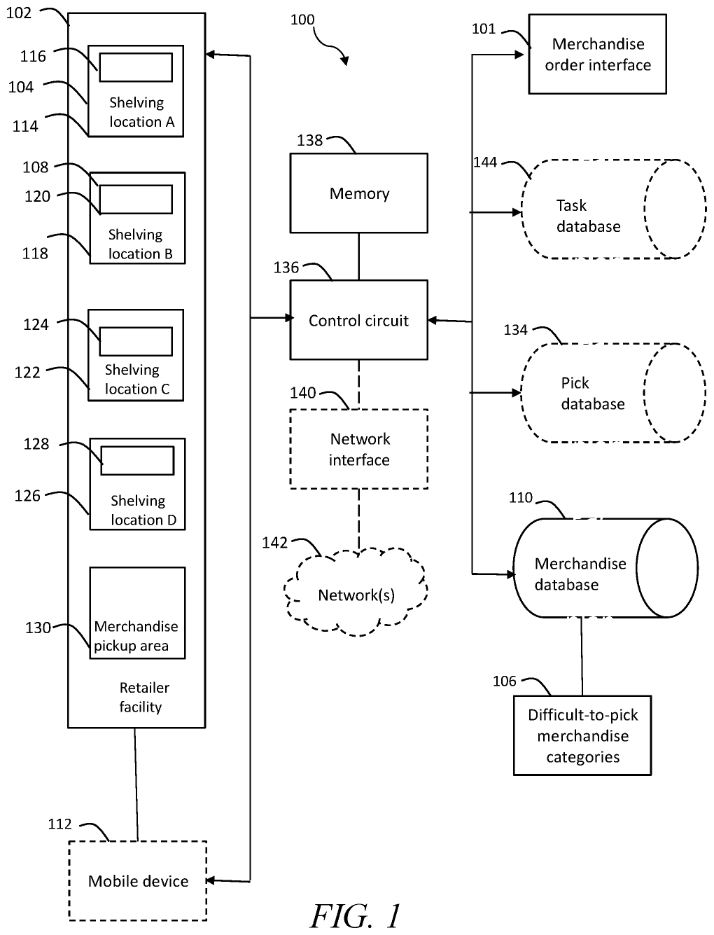

Referring to FIG. 1, there is shown a schematic diagram showing a system 100 for picking and assembling the merchandise items of a merchandise order. The system 100 generally determines two types of merchandise items in the order: routine pick items and difficult-to-pick items. It determines and assigns different pickers to pick these different types of merchandise categories.

The system 100 includes a merchandise order interface 101 configured to receive a merchandise order placed by a customer and including a plurality of merchandise items. The interface 101 may be located at a retailer facility 102 where the order is being assembled or it may be located at a separate location remote from the retailer facility. It is generally contemplated that a number of merchandise orders will be received, which may possibly have to be fulfilled in a certain sequence and/or by a certain deadline. It is generally contemplated that the merchandise items of the merchandise order may include one or more items that have been determined or categorized as difficult to pick.

The system 100 also includes a retailer facility 102 that includes multiple shelving locations 104 for multiple categories of merchandise items. Each shelving location 104 corresponds to a predetermined category of merchandise item, and some locations may include difficult-to-pick merchandise categories 106. In other words, it is generally contemplated that each category of merchandise item will have a designated shelving location 104. For example, with respect to food items, it is generally contemplated that cereals, eggs, types of bread, etc., will have designated and assigned shelving locations 104. Each shelving location 104 should preferably include a number of merchandise items 108 corresponding to the designated category.

Further, it is generally contemplated that retailer facility 102 may refer to any of various types of facilities. For example, a “retailer facility” may refer to shopping facilities or stores that are generally accessible to the public for shopping by consumers and for order and pick up by consumers. As another example, it may refer to fulfillment centers where employees may fulfill online orders from stores and consumers. The retailer facility may include a merchandise pickup area 130 for pick up of the merchandise order and/or may arrange for delivery of the order.

The system 100 also includes a merchandise database 110 with multiple records of the merchandise categories at the retailer facility 102. The merchandise database identifies a predetermined group of difficult-to-pick merchandise categories 106 that may be based on various criteria. In some forms, the difficult-to-pick merchandise categories may be one or more of the following: items stored in locked cases, items stored in non-public areas of the retailer facility; and/or items based on a low first-time pick percentage (as described further below). In one form, it is contemplated that the difficult-to-pick merchandise categories constitute items stored in locked cases and items stored in non-public areas of the retailer facility. However, in other forms, it is contemplated that the difficult-to-pick merchandise categories are determined solely by a low first-time pick percentage, which may be below a certain threshold. In other forms, the difficult-to-pick merchandise categories may be a combination of these three types of items.

FIG. 1 shows an example of a retailer facility 102 with multiple shelving locations 104 that are each intended for a particular group of merchandise items 108. More specifically, shelving location A (114) is intended for merchandise items A (116), shelving location B (118) is intended for merchandise items B (120), shelving location C (122) is intended for merchandise items C (124), and shelving location D (126) is intended for merchandise items D (128). So, for example, if some or all merchandise items A are incorrectly stocked at or moved to shelving location B, they may not be found by the picker/employee, which would reduce a first-time pick metric.

The system 100 may also include a pick database 134 containing a first-time pick metric corresponding to each shelving location 104. The first-time pick metric may be determined by the frequency an individual locates a predetermined category of merchandise item corresponding to each shelving location 104 based on the merchandise database 110. For example, in some forms, the first-time pick metric or percentage may be a measure across the day through all picking hours if items were available at the shelving location when pickers went to pick the item the first time an image of the item was displayed to them. Thus, it may be a useful indicator as to whether a certain category of merchandise item is a difficult-to-pick merchandise item.

The first-time pick metric is a general measurement of how well-organized a particular shelving location 104 is. The organization of a shelving location refers broadly to anything that delays or inhibits picking a merchandise item at the shelving location, including, without limitation, merchandise items being out of stock at the shelf, misplaced items, missing or poor labeling, out of date packaging or pricing information in a merchandise database, etc. Generally, the first-time pick metric is a percentage indicating how often a merchandise item 108 was found at its intended location, and it is an indicator of how well pickers can find items on the shelves. In this form, it is an indicator of the shelving location's performance, i.e., its organization. As stated, the first-time pick metric may be determined by such circumstances as an item being out of stock, being located in a shelving location 104 different than indicated by the planogram or merchandise database 110, and having new packaging or pricing. A stores' overall first-time pick metric (or score) may be determined as an average of the first-time pick metrics for the merchandise categories.

Pickers often have a limited amount of time in which to pick the items of a merchandise order. If one item cannot be readily found, it may be skipped and may have to be obtained later. So, in some forms, the first-time pick metric may be considered to be the frequency a predetermined category of merchandise item corresponding to each shelving location 104 can be located within a certain amount of time.

The system may therefore include a pick database 134 that may be used to identify some or all difficult-to-pick merchandise items. The pick database 134 may contain a first-time pick metric corresponding to each shelving location 104, and the first-time pick metric may be determined by the frequency of an individual locating a predetermined category of merchandise item at its designated shelving location 104. In addition, the predetermined group of difficult-to-pick merchandise categories 106 may include categories with first-time pick metrics below a certain threshold. In addition, although this disclosure separately addresses a merchandise database 110 and a pick database 134, it should be understood that these databases may constitute as single, combined database (and may also be combined with other databases).

The system 100 also includes a control circuit 136 that is configured to perform certain operations. In this context, the term control circuit 136 refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 136 may be configured (for example, by using corresponding programming stored in a memory as will be well understood by those skilled in the art) to carry out one or more of the steps, actions, and/or functions described herein.

As shown in FIG. 1, the control circuit 136 is coupled to a memory 138 and to a network interface 140 and wireless network(s) 142. The memory 138 can, for example, store non-transitorily computer instructions that cause the control circuit 136 to operate as described herein, when the instructions are executed, as is well known in the art. Further, the network interface 140 may enable the control circuit 136 to communicate with other elements (both internal and external to the system 100). This network interface 140 is well understood in the art. The network interface 140 can communicatively couple the control circuit 136 to the wireless network 142 and whatever other networks 142 may be appropriate for the circumstances. The control circuit 136 may form part of, be coupled to, or in communication with a server of the retailer facility 102 and may make use of cloud databases and/or operate in conjunction with a cloud computing platform. As can be seen, the control circuit 136 may be coupled to one or more databases (such as merchandise database 110 and pick database 134).

The control circuit 136 receives the merchandise order from the merchandise order interface 101. As stated, the merchandise order interface 101 may or may not be located at the retailer facility 102. It is generally contemplated that the retailer facility receives multiple merchandise orders over time that need to be fulfilled.

The control circuit 136 determines merchandise items 108 in the merchandise order that are within the predetermined group of difficult-to-pick merchandise categories 106. It is generally contemplated that the merchandise items 108 will generally fall into one of two groups: routine-to-pick items and difficult-to-pick items. In one form, a merchandise record may have a default setting as a routine-to-pick item and a flag or field may be checked to change this default setting to indicate a difficult-to-pick item. The control circuit 136 may go item-by-item and determine the items in each group.

The control circuit 136 also selects a first picker with access to the difficult-to-pick merchandise items. In one form, it is generally contemplated that the difficult-to-pick items may fall within one or departments. For example, the predetermined group of difficult-to-pick merchandise categories may include entertainment, apparel, and seasonal products. Further, the first picker may be selected from a department corresponding to the difficult-to-pick merchandise items.

The retailer facility 102 may include various products in different functional areas that are in locked cases. For example, the entertainment department may include a number of locked cases (such as for wireless earbuds) such that an individual from that department might more quickly access such products. The entertainment area may have relatively expensive products that are often secured in locked cases (to deter theft), such as, for example, wireless earbuds. A general order filler may not have a key to access the case and may have to wait for a skilled picker to open the case. Often, the general order filler will skip it because it is taking too long. Other items in the entertainment are oversize (such as televisions) and may not fit on the cart of a general order filler. Some products (such as televisions) may be so large that they are not on the sales floor (they may be stored in a backroom), so the general order filler may not be able to find the item easily. In contrast, the entertainment employees are very familiar and knowledgeable regarding these products. They have the keys, know where the oversize products are, and have equipment to move products better.

There are other types of difficult-to-pick merchandise items in various departments. For example, the apparel department may include clothing that is generally similar in appearance but with slightly different sizes, colors, etc., that an individual in the department would more readily locate. Similarly, printer ink cartridges may be difficult to distinguish because they generally look similar to one another but may have special codes or identifiers. General order fillers may have a difficult time locating a specific one, but a skilled picker may stock them so they have a better understanding of where specific ones are located. As another example, seasonal products may move to various locations at uncertain times, and planograms and merchandise databases may not be up to date with the type and location of seasonal product. So, an individual knowledgeable about seasonal products may more readily pick these products than a general order filler. In some forms, it is contemplated that, if a first-time pick percentage decreases or is below a certain threshold, picking a certain merchandise category may be converted from a general order filler task to a skilled picker task. Also, it is contemplated that more than one type of skilled picker may be used if the merchandise order includes merchandise items from more than one such department, such as, for example, a merchandise order including both entertainment and apparel products.

The control circuit 136 also instructs the first picker to assemble difficult-to-pick merchandise items 106 and deliver them to a predetermined location. For example, the predetermined location may be a designated location in a non-public area of the retailer facility 102. Alternatively, the predetermined location might be a service center/counter or area within the first picker's department. In some circumstances, there may be multiple pickers assembling the difficult-to-pick items 106.

The control circuit 136 further instructs a second picker to assemble merchandise items not within the predetermined group of difficult-to-pick merchandise categories 106. It is generally contemplated (although not required) that the second picker may be a general order filler, who picks the routine-to-pick merchandise items disposed throughout the retailer facility 102. Also, depending on the size of the merchandise order, it is also contemplated that there are multiple order fillers to assemble the routine-to-pick merchandise items.

In addition, the control circuit 136 instructs the second picker to consolidate the difficult-to-pick merchandise items 106 delivered to the predetermined location and the merchandise items assembled by the second picker. In some forms, the consolidated merchandise items may be made available for pick up by the customer or delivery to the customer or a store. For example, if the difficult-to-pick items included entertainment products and these entertainment products were stored in a non-public backroom area, then the second picker would collect these entertainment products from the backroom area. Further, it should be understood that this consolidation instruction may be implicit in the instruction to the second picker to pick routine-in-pick merchandise items. In other words, the second picker may be informed or become aware that the merchandise order includes difficult-to-pick merchandise items and will thereby be informed that he or she will need to consolidate these difficult-to-pick merchandise items with the other remaining merchandise items at some time.

Optionally, it is also contemplated that the control circuit 136 may perform additional operations and communications to facilitate coordination of the pickers and overall assembly of the merchandise order. For example, the control circuit 136 may transmit the instruction to the first picker to assemble difficult-to-pick merchandise items 106 to a mobile device 112 of the first picker and may receive a response to the instruction from the first picker. It is generally contemplated that the first picker may accept, decline, or otherwise acknowledge the task of picking the difficult-to-pick merchandise items via his or her mobile device 112.

Next, the control circuit 136 transmits an instruction to assemble the difficult-to-pick merchandise items 106 to a mobile device 112 of a third picker if the first picker declines. In other words, if the first picker declines for some reason (he or she has too many other tasks), then a third picker is selected to assemble the difficult-to-pick merchandise items. A third picker having access to the difficult-to-pick merchandise items 106 is selected. So, for example, if the difficult-to-pick merchandise item is an entertainment product, then the third picker may be selected from the entertainment department.

The control circuit 136 also may determine that at least one of the difficult-to-pick merchandise items 106 is an item intended for transport by more than one individual and may select multiple pickers to transport the item to a designated area for pick up. For example, the difficult-to-pick item may be an oversized item, such as a television, from the entertainment department. In one form, the corresponding merchandise record in the merchandise database 110 may be flagged to indicate that it is oversized or transport requires two individuals. In this circumstance, the control circuit 136 may select two pickers to collect and transport the item. In other circumstances, a single skilled picker may be familiar with equipment that may be used to transport an oversized item, which would be another reason to assign the task to a skilled picker, rather than a general order filler.

Further, the control circuit 136 may receive a notification from the first picker that the difficult-to-pick merchandise items 106 have been assembled and may notify the second picker that the difficult-to-pick merchandise items 106 are ready for consolidation with the merchandise items of the order assembled by the second picker. In other words, the actions of the first picker and second picker may be coordinated with one another. Once the first picker provides notice that the difficult-to-pick items have been assembled, the second picker may use this information to schedule his tasks of assembly and consolidation.

The control circuit 136 may also receive a notification that the merchandise order has been consolidated and is ready for pick up by the customer (in those circumstances where the order is for pick up). In one form, when the second picker has completed consolidation, he or she may indicate via mobile device 112 that the task has been completed. The assembled merchandise order may be made available for pick up at a merchandise pick up area at the retailer facility 102 or may be made available for delivery. The control circuit 136 may then, for example, transmit a notification to a customer to pick up the merchandise order or may transmit a notification to a delivery driver to make the delivery.

The control circuit 136 selects a first picker with access to the difficult-to-pick merchandise items 106. In one form, selecting a first picker with access to the difficult-to-pick merchandise items 106 may include accessing an active directory of pickers that are available at the retailer facility 102 and determining a picker in a department corresponding to a difficult-to-pick merchandise item 106. For example, the control circuit 136 may access a timeclock or employee database (or similar database) indicating the pickers who may be present at the retailer facility 102. Further, this database may include job codes or other identifiers indicating the department of the picker, which may be used to match categories of difficult-to-pick merchandise items 106 with a picker from a corresponding department.

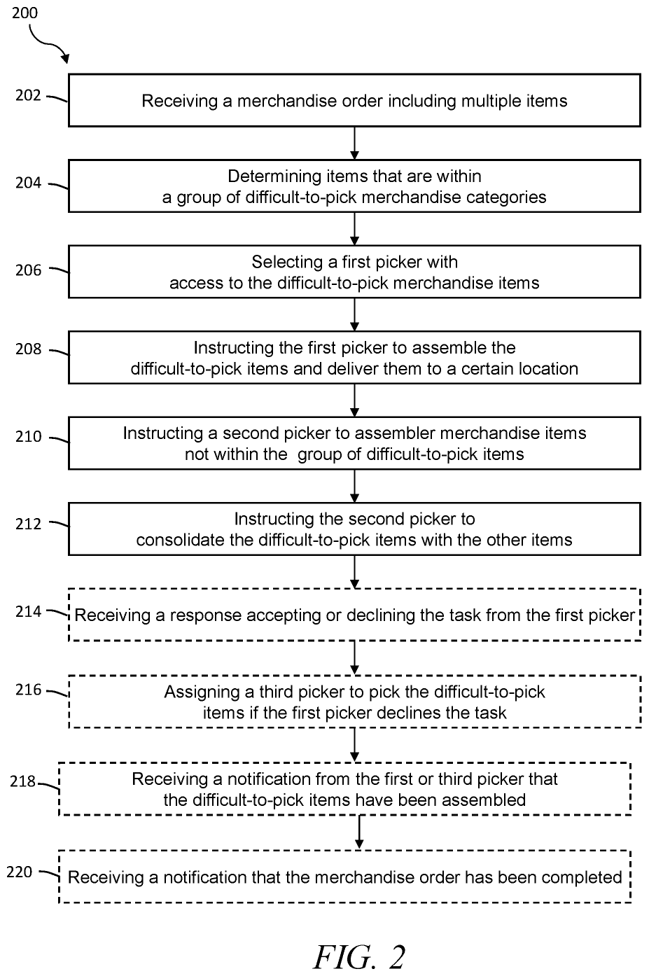

Referring to FIG. 2, there is shown a process 200 for assembling merchandise items of a merchandise order. At a high level, the process 200 generally divides the items into two groups: routine-to-pick items and difficult-to-pick items. One or more pickers are instructed to pick the items of the respective groups. The items are then consolidated.

At block 202, a merchandise order is received that includes multiple merchandise items. It is generally contemplated that it is received at a retailer facility, which may be a shopping facility, store, fulfillment center, etc. In one form, it may involve an online pick-up and delivery database, which may correspond generally to order fulfillment involving dispensing an order curbside to a customer, making it available at a merchandise pick up area in the retailer facility, or delivering the order to a customer or store.

At block 204, items are determined that are within a group of difficult-to-pick merchandise categories. In one form, it is contemplated that these items are indicated by a flag or field in a merchandise database. Also, in one form, it is contemplated that these items may be determined by whether they are stored in locked cases, stored in a backroom, and/or associated with a low first-time pick metric. In another form, these items may be determined on a department basis, such as, for example, determining that items in the entertainment, apparel, and/or or seasonal areas are difficult-to-pick items. Alternatively, they may be based on some combination of status (such as, for example, low first-time pick metric) and department (such as, for example, entertainment).

At block 206, a first picker is selected with access to the difficult-to-pick items. In one form, this first picker may be a skilled picker associated with a specific department or functional area of the retailer facility. In another form, it might be a skilled picker based on experience level or time working at the retailer facility. Further, it should be understood that multiple pickers may be selected for difficult-to-pick items. This circumstance might arise where the items in the merchandise order are from multiple specialized areas and/or where a single item might require the efforts of multiple pickers (such as an oversized television).

At block 208, the first picker is instructed to assemble the difficult-to-pick items and deliver them to a certain location. For example, if the first picker is in the entertainment section, he or she might retrieve and store difficult-to-pick merchandise item(s) at a service center or counter. Alternatively, the difficult-to-pick merchandise items might be stored at a backroom or other non-public area of the retailer facility.

At block 210, a second picker is instructed to assemble merchandise items that are not within the group of difficult-to-pick items. The second picker (or pickers) may be general order fillers and may assemble the remaining items in the merchandise order. At block 212, the second picker (or pickers) are instructed to consolidate the difficult-to-pick items (that were assembled by the first picker (or skilled picker)) with the other items that they assembled themselves (the routine-to-pick items). The merchandise order is then completed and may be made available for pick up or delivery.

Blocks 214-220 illustrate some additional optional steps. At block 214, a response is received from the first picker accepting or declining the task to pick the difficult-to-pick items. In one form, it is contemplated that the first and second pickers are communicating with the system via mobile devices. In this form, the first picker may accept or decline the task via his or her mobile device.

At block 216, if the first picker declines the task, it is assigned to a third picker. In one form, it is generally contemplated that the third picker is a skilled picker who may be determined based on the same sort of criteria used to determine the first picker. For example, they may both be members associated with the same department. In one form, it is also contemplated that the third picker may accept or decline the task via mobile device.

At block 218, a notification is received from the first picker (or from the third picker if the first picker declined) that the difficult-to-pick items have been assembled. In turn, the second picker may be notified that the difficult-to-pick items are ready for retrieval by the second picker. The second picker then knows that he or she may consolidate the difficult-to-pick items with the items he or she has assembled. It should be understood that notifications, as used in this disclosure, may refer generally in nature to either push or pull sorts of notifications.

At block 220, a notification is received that the merchandise order has been completed. Once the second picker consolidates the two groups of items, he or she can indicate that the merchandise order has been assembled. Once the notification is received, the completed merchandise order can be made available for pick up or delivery.

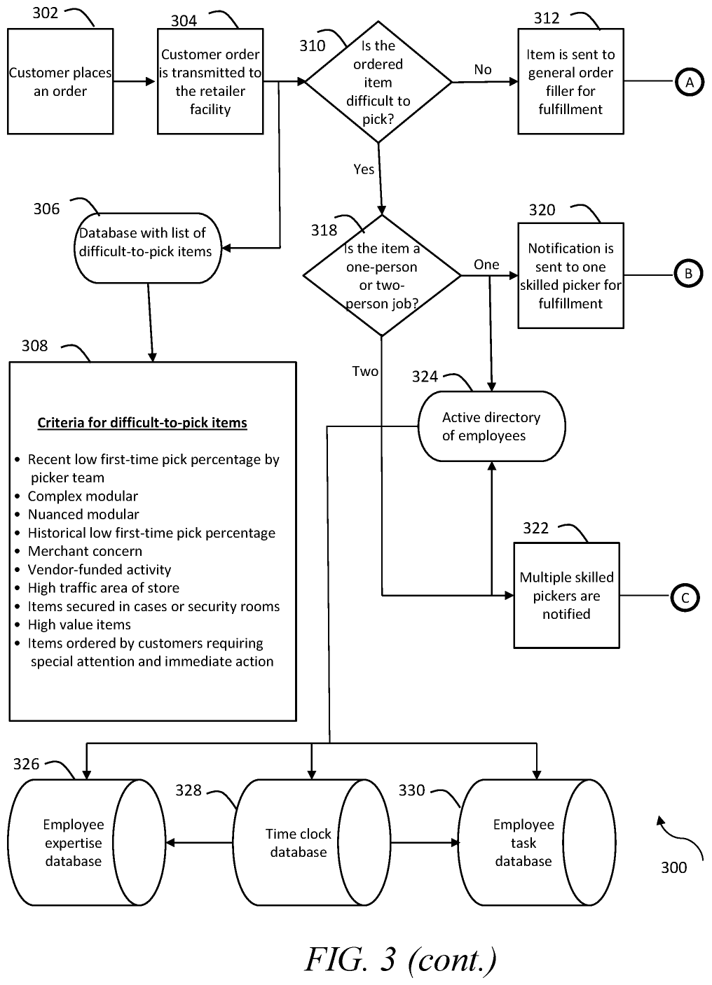

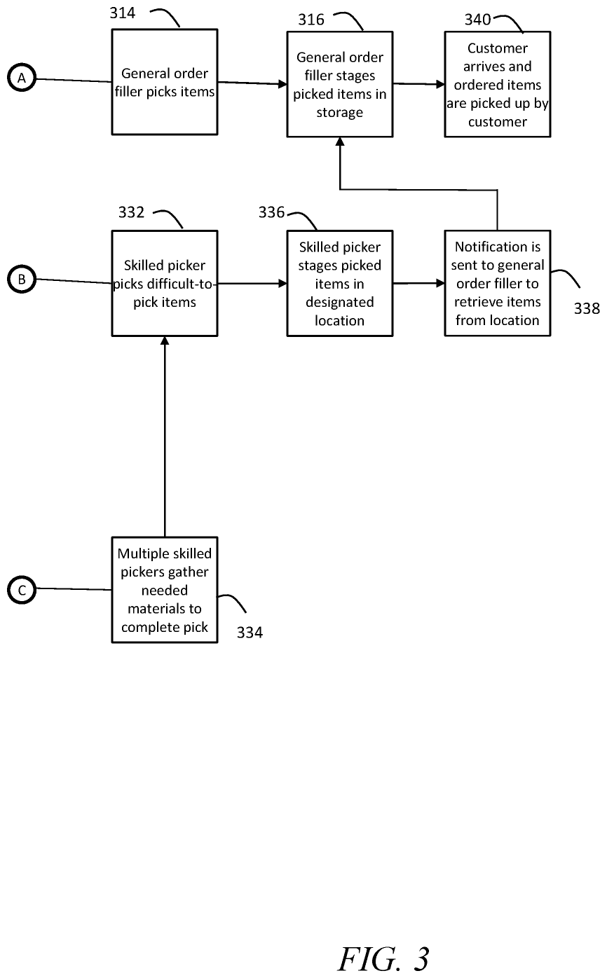

Referring to FIG. 3, there is shown a process 300 for assembling the merchandise items of a merchandise order placed by a customer. In one form, it is generally contemplated that the merchandise items are assembled and made available for pick up by a customer. The process 300 may incorporate some or all of the components and operations addressed above with respect to system 100 and process 200.

At block 302, a customer places a merchandise order. It is generally contemplated that the customer may place the order in various ways, such as, for example, by placing an online order via a mobile device or other computing device. At block 304, the customer order is transmitted to the retailer facility. In one form, the customer order may be received at a merchandise order interface and is received at, or may be routed, to the retailer facility. The interface may located at the retailer facility or remote from the retailer facility.

As shown at block 306, it is generally contemplated that the order may include type types of merchandise items: items that are fairly routine to pick (or items not requiring special treatment) and difficult-to-pick items (or items requiring special treatment). Block 306 shows a database that includes some sort of list (or field) identifying difficult-to-pick items. These difficult-to-pick items may be determined based on one or more specific criteria.

At block 308, there are shown examples of criteria, which may be used alone or in combination with some or all of the other criteria. These examples include: items that have a recent low first-time pick percentage by the picker team (for example, items may be determined based on whether their recent first-time pick percentages are below a certain threshold); items that are displayed and arranged at a complex or nuanced modular or shelving location (for example, the nature of the shelving location may contribute to the difficulty in picking them); items that have a historical low first-time pick percentage (for example, there may items that area historically known to be difficult to pick); items that are the subject of merchant concern and/or vendor-funded activity (for example, certain merchants/vendors have inquired why their products are below their expectations and/or have provided funding or support relating to sales of their products); items that are displayed and arranged in high traffic areas of the retailer facility/store (for example, it may be desirable to not have the item be treated as a routine pick where there may be interference with customers at the store); items secured in cases or security rooms (for example, these cases and rooms may be locked or require special access); high value items and certain other items ordered by customers (for example, high value items may be subject to special security/access and certain other items ordered by customers may require special attention and immediate action). As should be understood, various combinations of criteria are possible, and other criteria may also be used (alone or in combination with these criteria).

At block 310, each item of the merchandise order is considered to determine whether it is a difficult-to-pick item. At block 312, if an item is not a difficult-to-pick item, it may be added to a list of routine-to-pick items to be sent to a general order filler for fulfillment. At block 314, the general order filler picks the routine-to pick items. At block 316, once he or she completed picking all of the routine-to-pick items, he or she may then stage these picked items in storage or at some other location. The general order filler may complete his or her picking task before the skilled picker has completed his or her own task, and therefore, it may be desirable to store the items in some location. Alternatively, if the skilled picker has completed his or her own task, it may be desirable for the general order filler to store the completed order somewhere until the customer arrives at the store to pick up the order.

At block 310, for items of the merchandise order that are considered difficult to pick, the process 300 continues to block 318. At block 318, each difficult-to-pick item is considered if picking the item will be a one-person or two-person job/task. At block 320, if the difficult-to-pick item will be a one-person picking task, then a notification is sent to one skilled picker for picking/fulfillment. In some forms, it is contemplated that a list of these one-person picking tasks may be the subject of the notification. At block 322, if the difficult-to-pick item will be a two-person task (such as for oversized items), then multiple skilled pickers are notified. In some forms, it is contemplated that a list of these two-person picking tasks may be sent to the multiple skilled pickers.

At block 324, it is contemplated that an active directory of employees is consulted in order to determine and select the skilled pickers. This active directly may help identify the skilled pickers who are currently present at the store, and those skilled pickers who have sufficient training or expertise with the specific categories of difficult-to-pick items. For example, if the difficult-to-pick items are from the entertainment department, it may be desirable to determine and selection entertainment employees who are currently at the store. In one form, the active directory makes use of an employee expertise database at block 326 (to determine employees that have the requisite training or expertise), a time clock database at block 328 (to determine employees that are currently present at the store or to determine when they might be available), and/or an employee task database at block 330 (to determine if employees are busy with other tasks and/or to monitor the status and progress of the current picking task).

At block 332, after a skilled picker has been picked for the one-person jobs, he or she picks the items. Similarly, at block 334, after two skilled pickers have been picked the two-person jobs, they pick those items. In one form, it is contemplated that the skilled picker selected for the one-person jobs will also be one of the two skilled pickers for the two-person jobs. At block 336, the skilled picker for the one-person jobs coordinates and stages all of the difficult-to-pick items at a designated location. The designated location may, for example, be a service center or counter, a non-public area of the store, or a merchandise pick up area of the store.

At block 338, a notification is sent to the general order filler to retrieve the difficult-to-pick items from the designated location. In one form, a notification may be sent and the general order filler may have to coordinate transport of the difficult-to-pick items from the designated location, especially if one or more of those items is an oversized item. At block 316, the general order filler consolidates the difficult-to-pick items with the items he has picked (or will pick). Then, at block 340, the customer arrives at the store and picks up his completed merchandise order.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for assembling merchandise items ordered by customers, the system comprising:
a merchandise order interface configured to receive a merchandise order placed by a customer and including a plurality of merchandise items;
a retailer facility comprising a plurality of shelving locations, each shelving location corresponding to a predetermined category of merchandise item, and comprising a merchandise pickup area configured for pick up of the merchandise order;
a merchandise database containing a plurality of records of the merchandise categories at the retailer facility, the merchandise database identifying a predetermined group of difficult-to-pick merchandise categories comprising items stored in locked cases and in non-public areas of the retailer facility;
a control circuit communicatively coupled to the merchandise order interface and the merchandise database, the control circuit configured to:
receive the merchandise order from the merchandise order interface;
determine merchandise items in the merchandise order that are within the predetermined group of difficult-to-pick merchandise categories;
select a first picker with access to the difficult-to-pick merchandise items;
instruct the first picker to assemble difficult-to-pick merchandise items and deliver them to a predetermined location;
instruct a second picker to assemble merchandise items not within the predetermined group of difficult-to-pick merchandise categories; and
instruct the second picker to consolidate the difficult-to-pick merchandise items delivered to the predetermined location and the merchandise items assembled by the second picker.

2. The system of claim 1, further comprising:
a pick database communicatively coupled to the control circuit, the pick database containing a first-time pick metric corresponding to each shelving location, the first-time pick metric determined by the frequency of an individual locating a predetermined category of merchandise item corresponding to each shelving location; and
wherein the predetermined group of difficult-to-pick merchandise categories further comprises categories with first-time pick metrics below a predetermined threshold.

3. The system of claim 1, wherein the predetermined group of difficult-to-pick merchandise categories are selected from entertainment, apparel, and seasonal products.

4. The system of claim 1, wherein the first picker is selected from a department corresponding to the difficult-to-pick merchandise items.

5. The system of claim 1, wherein the control circuit is configured to:
transmit the instruction to the first picker to assemble difficult-to-pick merchandise items to a mobile device of the first picker; and
receive a response to the instruction from the first picker.

6. The system of claim 5, wherein the control circuit is configured to:
transmit an instruction to assemble the difficult-to-pick merchandise items to a mobile device of a third picker if the first picker declines, the third picker having access to the difficult-to-pick merchandise items.

7. The system of claim 1, wherein the control circuit is configured to:
determine that at least one of the difficult-to-pick merchandise items is an item intended for transport by a plurality of pickers; and
select a plurality of pickers to transport the item to a designated area for pick up.

8. The system of claim 1, wherein the control circuit is configured to:
receive a notification from the first picker that the difficult-to-pick merchandise items have been assembled; and
notify the second picker that the difficult-to-pick merchandise items are ready for consolidation with the merchandise items of the order assembled by the second picker.

9. The system of claim 1, wherein the control circuit is configured to:
receive a notification that the merchandise order has been consolidated and is ready for pick up by the customer.

10. The system of claim 1, wherein selecting a first picker with access to the difficult-to-pick merchandise items comprises accessing an active directory of pickers that are available at the retailer facility and determining a picker in a department corresponding to a difficult-to-pick merchandise item.

11. A method for assembling merchandise items ordered by customers, the method comprising:
receiving, by a control circuit communicatively coupled to a merchandise order interface and a merchandise database, a merchandise order from the merchandise order interface placed by a customer and including a plurality of merchandise items, wherein a merchandise pickup area at a retailer facility is configured for pick up of the merchandise order, wherein the retailer facility includes a plurality of shelving locations and each shelving location corresponds to a predetermined category of merchandise item, wherein a plurality of records are stored in the merchandise database of the merchandise categories at the retailer facility, wherein the merchandise database identifies a predetermined group of difficult-to-pick merchandise categories comprising items stored in locked cases and in non-public areas of the retailer facility;
determining, by the control circuit, merchandise items in the merchandise order that are within the predetermined group of difficult-to-pick merchandise categories;
selecting, by the control circuit, a first picker with access to the difficult-to-pick merchandise items;
instructing, by the control circuit, the first picker to assemble difficult-to-pick merchandise items and deliver them to a predetermined location;
instructing, by the control circuit, a second picker to assemble merchandise items not within the predetermined group of difficult-to-pick merchandise categories; and
instructing, by the control circuit, the second picker to consolidate the difficult-to-pick merchandise items delivered to the predetermined location and the merchandise items assembled by the second picker.

12. The method of claim 11, wherein:
a first-time pick metric is stored in a pick database corresponding to each shelving location, the first-time pick metric determined by the frequency of an individual locating a predetermined category of merchandise item corresponding to each shelving location; and
the predetermined group of difficult-to-pick merchandise categories further comprises categories with first-time pick metrics below a predetermined threshold.

13. The method of claim 11, wherein the predetermined group of difficult-to-pick merchandise categories is selected from entertainment, apparel, and seasonal products.

14. The method of claim 11, further comprising, by the control circuit, selecting the first picker from a department corresponding to the difficult-to-pick merchandise items.

15. The method of claim 11, further comprising, by the control circuit:
transmitting the instruction to the first picker to assemble difficult-to-pick merchandise items to a mobile device of the first picker; and
receiving a response to the instruction from the first picker.

16. The method of claim 15, further comprising, by the control circuit:
transmitting an instruction to assemble the difficult-to-pick merchandise items to a mobile device of a third picker if the first picker declines, the third picker having access to the difficult-to-pick merchandise items.

17. The method of claim 11, further comprising, by the control circuit:
determining that at least one of the difficult-to-pick merchandise items is an item intended for transport by a plurality of pickers; and
selecting a plurality of pickers to transport the item to a designated area for pick up.

18. The method of claim 11, further comprising, by the control circuit:
receiving a notification from the first picker that the difficult-to-pick merchandise items have been assembled; and
notifying the second picker that the difficult-to-pick merchandise items are ready for consolidation with the merchandise items of the order assembled by the second picker.

19. The method of claim 11, further comprising, by the control circuit:
receiving a notification that the merchandise order has been consolidated and is ready for pick up by the customer.

20. The method of claim 11, wherein selecting a first picker with access to the difficult-to-pick merchandise items comprises accessing an active directory of pickers that are available at the retailer facility and determining a picker in a department corresponding to a difficult-to-pick merchandise item.
